(19) United States
(12) Patent Application Publication
(10) Pub. No.: US 2026/0080494 A1
(43) Pub. Date: Mar. 19, 2026

(54) AI-BASED CIVIL RIGHTS AND ASSET PROTECTION SURVEILLANCE SYSTEM AND METHOD

(71) Applicant: Norman Lloyd Johansen Jr., JR., Durham, NC (US)

(72) Inventor: Norman Lloyd Johansen Jr., JR., Durham, NC (US)

(21) Appl. No.: 19/065,008

(22) Filed: Feb. 27, 2025

Related U.S. Application Data
(60) Provisional application No. 63/695,961, filed on Sep. 18, 2024.

(51) Int. Cl. G06Q 50/26; G06Q 50/18; H04N 7/18

(52) U.S. Cl. CPC G06Q 50/265; G06Q 50/18; H04N 7/181; H04N 7/188

(57) ABSTRACT

A system and method that monitors and protects an individual's civil rights and assets during a law enforcement encounter or emergency services encounter using AI-based surveillance. An AI-based surveillance system comprising an AI-based surveillance system controller and a plurality of surveillance devices located are installed internally and/or externally on a vehicle or building for providing real-time audio and video surveillance with respect to either law enforcement encounter or emergency services encounter which is continually analyzed by the AI-based surveillance system to detect any possible civil rights violation or any physical asset that is being compromised. The AI-based surveillance system from such analysis will alert the individuals involved of any such issue and also provide a legal synopsis of their rights as a function of the system's real-time observations.

### CROSS-REFERENCE TO RELATED APPLICATION

This application claims the benefit of U.S. Provisional Patent Application No. 63/695,961 filed Sep. 18, 2024, which is hereby incorporated by reference herein in its entirety.

### FIELD OF THE INVENTION

The present invention relates generally to law enforcement, and more particularly, to a system and method that monitors and protects an individual's civil rights and assets during a law enforcement encounter using artificial intelligence (AI)-based surveillance.

### BACKGROUND OF THE INVENTION

In society today, the actions of law enforcement officers are receiving extreme scrutiny to address actual or perceived inequities and malfeasance. Indeed, the societal temperature on such law enforcement matters has led to dangerous and destructive rioting in major U.S. cities. There is general agreement that these law enforcement individuals have a difficult job and regularly risk their lives during their job tours. However, respect shown by the general public for law enforcement that was once standard in society is now diminished or has disappeared completely. From another perspective, law enforcement personnel in a few recent highly publicized law enforcement encounters have demonstrated a lack of professionalism and in some cases violated the civil rights of the individual subject to the law enforcement encounter.

During traffic stops (routine or otherwise), the ability of law enforcement officers and civilians to effectively communicate with one another is often critical to the safety of both the law enforcement officers and civilians, and the surrounding public. However, in many cases, traffic stops are particularly anxiety-inducing for law enforcement officers and civilians alike such that observed behaviors by one party during a physical interaction can be easily misinterpreted as threatening and/or prejudicial by another. Such misinterpretations can lead to unwarranted escalations of violence. There have been too many recent incidents with tragic consequences between law enforcement officers and civilians. Thus, given the risks associated with encounters between law enforcement officers and civilians, there is an urgent need to reduce both the anxiety caused by such physical interactions and the likelihood of needless escalations of violence. Improving these relationships and the general feelings towards law enforcement is a further need together with new ways to measure and improve law enforcement performance.

Accordingly, there is a need for a system and method that improves the overall safety, effectiveness, and practices associated with law enforcement encounters.

### SUMMARY OF THE INVENTION

The present invention is directed to a system and method that monitors and protects an individual's civil rights and assets during a law enforcement encounter or emergency services encounter using AI-based surveillance.

In a first implementation of the invention, an AI-based surveillance system is provided that enables monitoring and protecting an individual's civil rights and assets during a law enforcement encounter or emergency services encounter involving a transportation article using AI-based surveillance. The AI-based surveillance system comprising at least a plurality of surveillance sensors aboard the transportation article and an AI-based surveillance system controller aboard the transportation article further comprising a processor and a memory storing instructions that when executed cause the processor to perform operations comprising: (i) recording a real-time surveillance video of the transportation article using at least the AI-based surveillance controller in combination with the plurality of surveillance devices aboard the transportation article; (ii) monitoring by the AI-based surveillance system using a first plurality of data collected by one or more of the plurality of surveillance devices for an occurrence of a law enforcement encounter involving the transportation article or an emergency services encounter proximate to the transportation article; (iii) responsive to a detection of an occurrence of a law enforcement encounter involving the transportation article:
(a) transmitting a request to receive a recorded video clip for a specified duration prior to the detected law enforcement encounter from the real-time surveillance video recording; (b) receiving by the AI-based surveillance system the recorded video clip requested; (c) triggering a start of a real-time law enforcement video recording associated with the detected law enforcement encounter; (d) responsive to the triggering of the start of the real-time law enforcement video recording, monitoring the law enforcement encounter by the AI-based surveillance system aboard the transportation article using a second plurality of data collected by the plurality of surveillance devices during a time period associated with the law enforcement encounter; (e) accessing and analyzing by the AI-based surveillance system at least one legal database and retrieving therefrom one or more applicable laws, regulations or ordinances governing the law enforcement encounter; (f) providing by the AI-based surveillance system, using the one or more applicable laws, regulations or ordinances governing the law enforcement encounter accessed and analyzed, to at least one occupant within the transportation article a legal synopsis of their individual legal rights; (g) receiving by the AI-based surveillance system one or more occupant questions; (h) analyzing by the AI-based surveillance system the one or more occupant questions received and transmitting one or more answers thereto to the at least one occupant; (n) detecting by the AI-based surveillance system an end to the law enforcement encounter; (j) responsive to the detection of the end of the law enforcement encounter, triggering an end to the real-time law enforcement video recording; and (k) storing a record associated with the law enforcement encounter;
(iv) otherwise, responsive to a detection of an occurrence of an emergency services encounter proximate to the transportation article; (a) sensing by one or more of the plurality of surveillance devices a make-way signal initiated by and associated with the emergency services encounter; (b) responsive to the make-way signal sensed, confirming by the AI-based surveillance system using a third plurality of data collected by the plurality of surveillance devices at least one emergency vehicle is approaching the transportation article; (c) transmitting to a controlling body of the transportation article an emergency yield command to initiate moving the transportation article to a position clear of the approaching at least one emergency vehicle.

In a second aspect, a method is provided for monitoring and protecting an individual's civil rights and assets during a law enforcement encounter or emergency services encounter involving a transportation article using AI-based surveillance. The method comprising: (i) recording a real-time surveillance video of the transportation article using at least an AI-based surveillance system comprising at least an AI-based surveillance controller in combination with the plurality of surveillance devices aboard the transportation article; (ii) monitoring by the AI-based surveillance system using a first plurality of data collected by one or more of the plurality of surveillance devices for an occurrence of a law enforcement encounter involving the transportation article or an emergency services encounter proximate to the transportation article; (iii) responsive to a detection of an occurrence of a law enforcement encounter involving the transportation article:
(a) transmitting a request to receive a recorded video clip for a specified duration prior to the detected law enforcement encounter from the real-time surveillance video recording; (b) receiving by the AI-based surveillance system the recorded video clip requested; (c) triggering a start of a real-time law enforcement video recording associated with the detected law enforcement encounter; (d) responsive to the triggering of the start of the real-time law enforcement video recording, monitoring the law enforcement encounter by the AI-based surveillance system aboard the transportation article using a second plurality of data collected by the plurality of surveillance devices during a time period associated with the law enforcement encounter; (e) accessing and analyzing by the AI-based surveillance system at least one legal database and retrieving therefrom one or more applicable laws, regulations or ordinances governing the law enforcement encounter; (f) providing by the AI-based surveillance system, using the one or more applicable laws, regulations or ordinances governing the law enforcement encounter accessed and analyzed, to at least one occupant within the transportation article a legal synopsis of their individual legal rights; (g) receiving by the AI-based surveillance system one or more occupant questions; (h) analyzing by the AI-based surveillance system the one or more occupant questions received and transmitting one or more answers thereto to the at least one occupant; (i) detecting by the AI-based surveillance system an end to the law enforcement encounter; (j) responsive to the detection of the end of the law enforcement encounter, triggering an end to the real-time law enforcement video recording; and (k) storing a record associated with the law enforcement encounter;
(iv) otherwise, responsive to a detection of an occurrence of an emergency services encounter proximate to the transportation article; (a) sensing by one or more of the plurality of surveillance devices a make-way signal initiated by and associated with the emergency services encounter; (b) responsive to the make-way signal sensed, confirming by the AI-based surveillance system using a third plurality of data collected by the plurality of surveillance devices at least one emergency vehicle is approaching the transportation article; (c) transmitting to a controlling body of the transportation article an emergency yield command to initiate moving the transportation article to a position clear of the approaching at least one emergency vehicle.

In a third aspect, a user device is provided for monitoring and protecting an individual's civil rights and assets during a law enforcement encounter or emergency services encounter using AI-based surveillance. The user device comprising at least a processor, a display and a memory storing instructions that when executed cause the processor to perform operations comprising: (i) (i) recording a real-time surveillance video of the transportation article using at least an AI-based surveillance system comprising at least an AI-based surveillance controller in combination with the plurality of surveillance devices aboard the transportation article; (ii) monitoring by the AI-based surveillance system using a first plurality of data collected by one or more of the plurality of surveillance devices for an occurrence of a law enforcement encounter involving the transportation article or an emergency services encounter proximate to the transportation article; (iii) responsive to a detection of an occurrence of a law enforcement encounter involving the transportation article:
(a) transmitting a request to receive a recorded video clip for a specified duration prior to the detected law enforcement encounter from the real-time surveillance video recording; (b) receiving by the AI-based surveillance system the recorded video clip requested; (c) triggering a start of a real-time law enforcement video recording associated with the detected law enforcement encounter; (d) responsive to the triggering of the start of the real-time law enforcement video recording, monitoring the law enforcement encounter by the AI-based surveillance system aboard the transportation article using a second plurality of data collected by the plurality of surveillance devices during a time period associated with the law enforcement encounter; (e) accessing and analyzing by the AI-based surveillance system at least one legal database and retrieving therefrom one or more applicable laws, regulations or ordinances governing the law enforcement encounter; (f) providing by the AI-based surveillance system, using the one or more applicable laws, regulations or ordinances governing the law enforcement encounter accessed and analyzed, to at least one occupant within the transportation article a legal synopsis of their individual legal rights; (g) receiving by the AI-based surveillance system one or more occupant questions; (h) analyzing by the AI-based surveillance system the one or more occupant questions received and transmitting one or more answers thereto to the at least one occupant; (i) detecting by the AI-based surveillance system an end to the law enforcement encounter; (j) responsive to the detection of the end of the law enforcement encounter, triggering an end to the real-time law enforcement video recording; and (k) storing a record associated with the law enforcement encounter;
(iv) otherwise, responsive to a detection of an occurrence of an emergency services encounter proximate to the transportation article; (a) sensing by one or more of the plurality of surveillance devices a make-way signal initiated by and associated with the emergency services encounter; (b) responsive to the make-way signal sensed, confirming by the AI-based surveillance system using a third plurality of data collected by the plurality of surveillance devices at least one emergency vehicle is approaching the transportation article; (c) transmitting to a controlling body of the transportation article an emergency yield command to initiate moving the transportation article to a position clear of the approaching at least one emergency vehicle.

In a fourth aspect, a method is provided for monitoring and protecting an individual's civil rights and assets during a law enforcement encounter involving a building structure using AI-based surveillance. The method comprising: (i) recording a real-time surveillance video of the transportation article using at least an AI-based surveillance system comprising at least an AI-based surveillance controller in combination with the plurality of surveillance devices integrated with the building structure; (ii) monitoring by the AI-based surveillance system using a first plurality of data collected by one or more of the plurality of surveillance devices for an occurrence of a law enforcement encounter involving the building structure; (iii) responsive to a detection of an occurrence of a law enforcement encounter involving the building structure:
(a) transmitting a request to receive a recorded video clip for a specified duration prior to the detected law enforcement encounter from the real-time surveillance video recording; (b) receiving by the AI-based surveillance system the recorded video clip requested; (c) triggering a start of a real-time law enforcement video recording associated with the detected law enforcement encounter; (d) responsive to the triggering of the start of the real-time law enforcement video recording, monitoring the law enforcement encounter by the AI-based surveillance system integrated with the building structure using a second plurality of data collected by the plurality of surveillance devices during a time period associated with the law enforcement encounter; (e) accessing and analyzing by the AI-based surveillance system at least one legal database and retrieving therefrom one or more applicable laws, regulations or ordinances governing the law enforcement encounter; (f) providing by the AI-based surveillance system, using the one or more applicable laws, regulations or ordinances governing the law enforcement encounter accessed and analyzed, to at least one occupant within or around the building structure a legal synopsis of their individual legal rights; (g) receiving by the AI-based surveillance system one or more occupant questions; (h) analyzing by the AI-based surveillance system the one or more occupant questions received and transmitting one or more answers thereto to the at least one occupant; (i) detecting by the AI-based surveillance system an end to the law enforcement encounter; (j) responsive to the detection of the end of the law enforcement encounter, triggering an end to the real-time law enforcement video recording; and (k) storing a record associated with the law enforcement encounter.

In a fourth aspect, a law enforcement AI-based civil rights and asset protection application (alternatively referred to herein as an “app”) may be executed on the AI-based surveillance system and/or a user device for monitoring and protecting an individual's civil rights and assets during a law enforcement encounter or emergency services encounter using AI-based surveillance in accordance with at least the method operations detailed herein above.

In a fifth aspect, a method is provided for monitoring and protecting an individual's civil rights and assets during an encounter involving another individual using AI-based surveillance where both individuals are civilians and not affiliated with any official governmental agency or authority. The method comprising: (i) recording a real-time surveillance video of a first individual using at least an AI-based surveillance system comprising at least an AI-based surveillance controller in combination with the plurality of surveillance devices; (ii) monitoring by the AI-based surveillance system using a first plurality of data collected by one or more of the plurality of surveillance devices for an occurrence of an encounter involving the first individual and a second individual; and (iii) responsive to a detection of an occurrence of the encounter; (a) transmitting a request to receive a recorded video clip for a specified duration prior to the detected encounter from the real-time surveillance video recording; (b) receiving by the AI-based surveillance system the recorded video clip requested; (c) triggering a start of a real-time encounter video recording associated with the detected encounter; (d) responsive to the triggering of the start of the real-time encounter video recording, monitoring the encounter by the AI-based surveillance system using a second plurality of data collected by the plurality of surveillance devices during a time period associated with the encounter; (e) accessing and analyzing by the AI-based surveillance system at least one legal database and retrieving therefrom one or more applicable laws, regulations or ordinances governing the encounter; (f) providing by the AI-based surveillance system, using the one or more applicable laws, regulations or ordinances governing the encounter accessed and analyzed, to the first individual a legal synopsis of their individual legal rights and/or other guidance with respect to the encounter; (g) receiving by the AI-based surveillance system one or more questions from the first individual; (h) analyzing by the AI-based surveillance system the one or more questions received and transmitting one or more answers thereto to the first individual; (i) detecting by the AI-based surveillance system an end to the encounter; (j) responsive to the detection of the end of the encounter, triggering an end to the real-time encounter video recording; and (k) storing a record associated with the encounter.

In another aspect, responsive to analyzing the real-time law enforcement video recording during the time period associated with the law enforcement encounter, the AI-based surveillance system may provide extemporaneous guidance to the individual involved in the law enforcement encounter in addition to or in lieu of a legal synopsis.

In another aspect, the transportation article is a car or a boat.

In another aspect, the law enforcement encounter is a traffic violation stop.

In another aspect, the plurality of surveillance devices comprise at least one or more cameras, microphones, communications devices, and location-tracking GPS devices.

In another aspect, at least one surveillance component collects a plurality of real-time video streams wherein each real-time video stream represents a different viewing angle of the law enforcement encounter.

In another aspect, a real-time search query is initiated of the at least one legal database directed to one or more applicable laws, regulations or ordinances governing the law enforcement encounter.

In another aspect, the real-time law enforcement video recording associated with the detected law enforcement encounter is transmitted to a cloud-based database for the storage thereof.

In another aspect, the legal synopsis provided contains at least one civil rights violation with respect to one or more occupants in the transportation article.

In another aspect, the plurality of surveillance devices are located on or within the transportation article.

In another aspect, all or a portion of the legal database is stored in a memory device associated with the AI-based surveillance system.

In another aspect, the law enforcement encounter involves at least one law enforcement officer and at least occupant of the transportation article.

In another aspect, the AI-based surveillance system monitors one or more interactions between the at least one law enforcement and the at least one occupant of the transportation article.

In another aspect, the controlling body of the transportation article is a driver thereof.

In another aspect, one or more AI agents may be utilized to interact with the environment (e.g., the law enforcement encounter) and perform the necessary tasks in assisting with the delivery of monitoring and protecting an individual's civil rights and assets during the law enforcement encounter or emergency services encounter using AI-based surveillance.

In another aspect, one or more of individuals (e.g., a law enforcement officer and/or or civilian involved with a law enforcement encounter and/or the emergency services encounter may employ one or more augmented reality (AR) devices, virtual reality (VR) devices, mixed reality (MR) devices and/or extended reality (XR) devices for delivering an immersive environment and experience in the course of monitoring and protecting an individual's civil rights and assets during a law enforcement encounter or emergency services encounter using AI-based surveillance.

In another aspect, the make-way signal is initiated by an emergency services vehicle (e.g., ambulance, fire truck, law enforcement vehicle, etc.).

The methods and systems described herein can be implemented by data processing systems, such as one or more smartphones, tablet computers, desktop computers, laptop computers, smart watches, wearables, audio accessories, on-board computer, and other user devices and consumer electronic devices. The methods and systems described herein can also be implemented by one or more data processing systems which execute executable computer program instructions, stored in one or more non-transitory machine readable media that cause the one or more data processing systems to perform the one or more methods described herein when the program instructions are executed. Thus, the embodiments described herein can include methods, data processing systems, and non-transitory machine readable media.

The above summary does not include an exhaustive list of all embodiments in this disclosure. All systems and methods can be practiced from all suitable combinations of the various aspects and embodiments summarized above, and also those disclosed in the detailed description below.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIGS. 1, 2, and 3 present a flowchart of illustrative operations for monitoring and protecting an individual's civil rights and assets during a law enforcement encounter or emergency services encounter involving a transportation article using AI-based surveillance in accordance with an embodiment;

FIGS. 4 and 5 present a flowchart of illustrative operations for monitoring and protecting an individual's civil rights and assets during a law enforcement encounter involving a building structure using AI-based surveillance in accordance with an embodiment;

FIG. 6 presents a high-level block diagram of an AI-based surveillance system controller in accordance with an embodiment;

FIG. 7 presents a diagram of an illustrative law enforcement encounter involving a transportation article configured with an AI-based surveillance system in accordance with an embodiment;

FIG. 8 a cloud network services architecture supporting an AI-based surveillance system in accordance with an embodiment;

FIG. 9 presents an illustrative AI-based civil rights and asset protection system in accordance with an embodiment;

FIG. 10 presents an illustrative user device configured in accordance with an embodiment;

FIG. 11 presents an illustrative architecture for a law enforcement AI-based civil rights and asset protection app in accordance with an embodiment;

FIG. 12 presents a diagram of an illustrative law enforcement encounter involving a building structure in accordance with an embodiment; and

FIG. 13 presents a diagram of a surveillance device layout with respect to a building structure configured with an AI-based surveillance system in accordance with an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention pertains to a system and method that monitors and protects an individual's civil rights and assets during a law enforcement encounter or emergency services encounter using AI-based surveillance. Importantly, the AI-based surveillance system and method provide an advantageous improvement of practical applications that include law enforcement, emergency services, surveillance devices, and artificial intelligence. Further, while the embodiments disclosed herein focus on interactions between a civilian and a law enforcement official it will be understood that the principles of the disclosed embodiments may apply equally to interactions between two civilians (i.e., where neither individual is affiliated with any official governmental agency or authority) to protect one of the civilians from any nefarious or other deleterious actions of the other civilian.

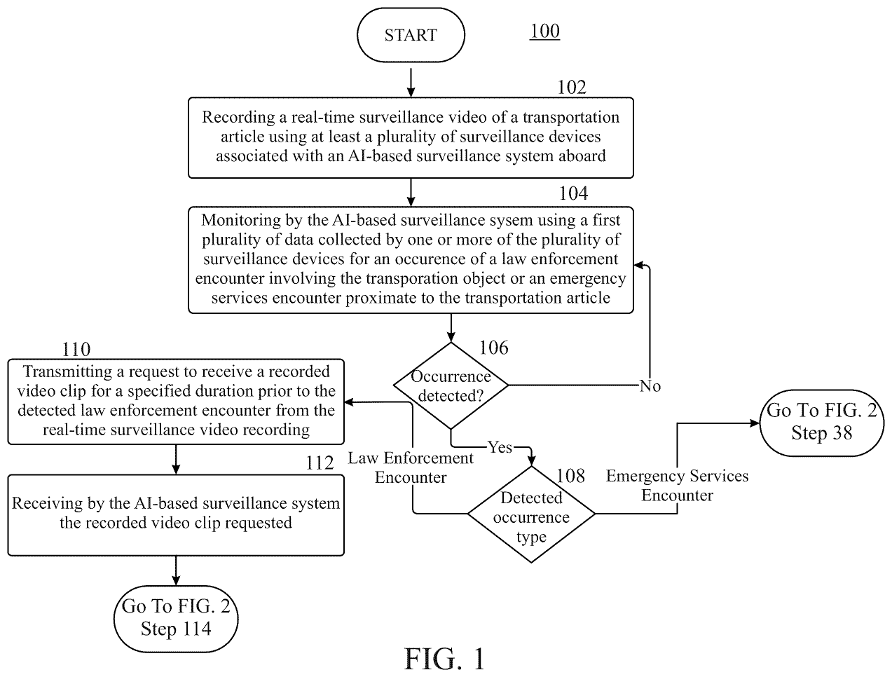

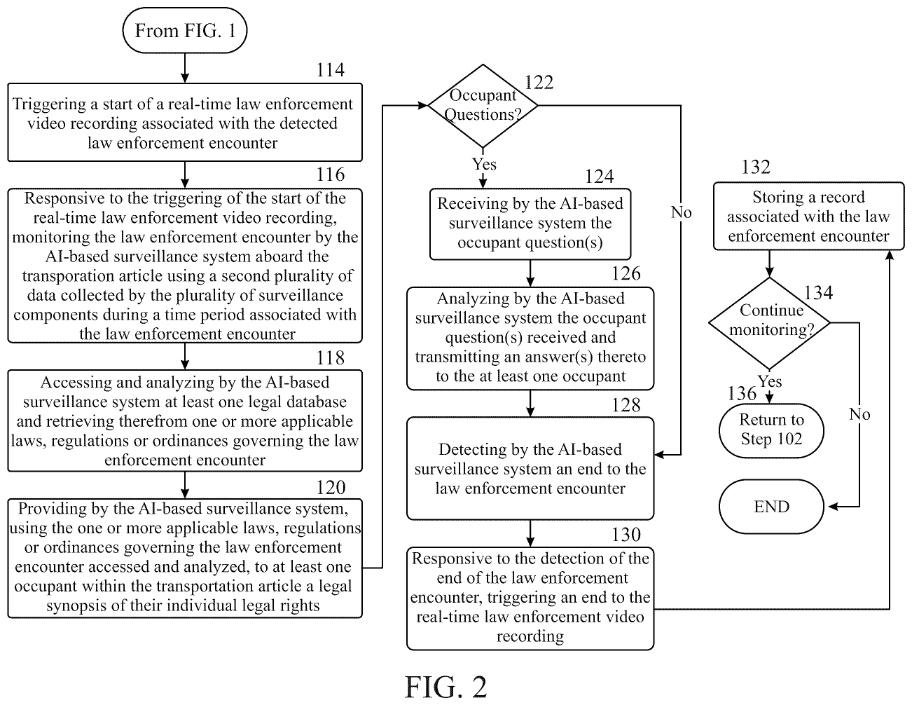

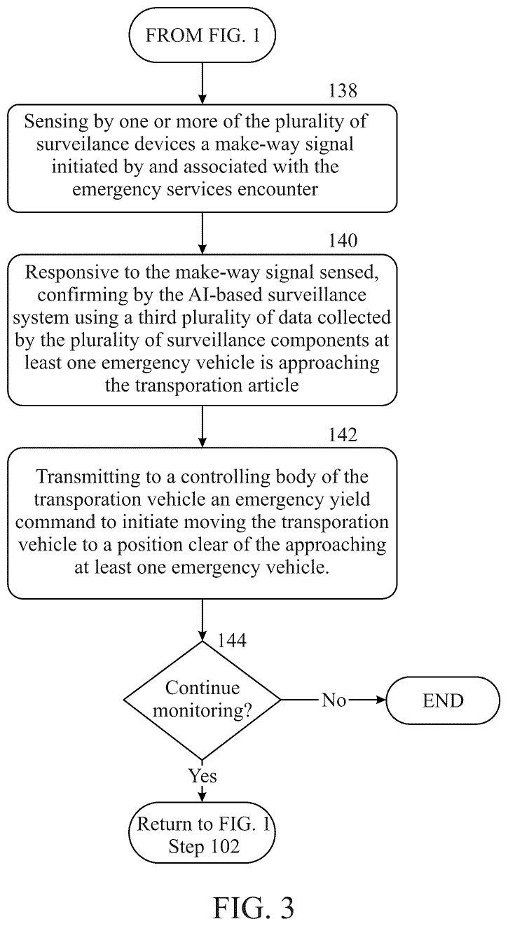

Turning our attention to FIGS. 1, 2, and 3, a flowchart of illustrative operations 100 for monitoring and protecting an individual's civil rights and assets during a law enforcement encounter or emergency services encounter involving a transportation article using AI-based surveillance in accordance with an embodiment. More particularly, at step 102, recording a real-time surveillance video of the transportation article using an AI-based surveillance system comprising at least an AI-based surveillance system controller in combination with the plurality of surveillance devices aboard the transportation article. In this way, a continuous real-time surveillance video feed is maintained of the transportation article (e.g., while driving) for use in the event of a law enforcement encounter, as will be further detailed hereinbelow. As will be appreciated, depending upon the audio/visual equipment type and capabilities, the visual perspective of the surveillance video feed may vary (e.g., first person perspective vs. third person perspective). In the subject embodiment, the surveillance operations are initiated automatically by the AI-based surveillance system (e.g., upon detection some motion of the transportation article or the presence of an occupant therein). In a further embodiment, an individual (e.g., the driver of the transportation article) may manually initiate the operations of the AI-based surveillance system at their discretion. In an embodiment, the plurality of surveillance devices are located on or within the transportation article. In an embodiment, the transportation article is either a car or a boat. In an embodiment, the law enforcement encounter is a traffic violation stop initiated by a law enforcement officer. In an embodiment, the plurality of surveillance devices comprise at least one or more cameras, microphones, communications devices, and location-tracking GPS devices. Illustratively, an occupant of the transportation article may also employ these surveillance devices to scan and/or verify various documents such as an insurance card, registration, driver license, etc. In an embodiment, the law enforcement encounter involves at least one law enforcement officer and at least occupant of the transportation article. At step 104, monitoring by the AI-based surveillance system using a first plurality of data collected by one or more of the plurality of surveillance devices for an occurrence of a law enforcement encounter involving the transportation article or an emergency services encounter proximate to the transportation article. In an embodiment, at least one surveillance component of the plurality of surveillance devices collects a plurality of real-time video streams wherein each real-time video stream represents a different viewing angle of the law enforcement encounter. In an embodiment, the monitoring includes at least one or more interactions between the at least one law enforcement and the at least one occupant of the transportation article. In this way, in accordance with the principles of the disclosed embodiments, the AI-based surveillance system is able to detect and provide alerts in the event of any potential or actual violation of law occurring during the law enforcement encounter.

At steps 106 and 108, responsive to a detection of an occurrence of a law enforcement encounter involving the transportation article, transmitting, at step 110, a request to receive a recorded video clip for a specified duration prior to the detected law enforcement encounter from the real-time surveillance video recording. Illustratively, the law enforcement encounter may be initiated by a law enforcement officer following the transportation article in their law enforcement vehicle and activating sirens and flashing lights or just by tailgating. Then, at step 112, receiving by the AI-based surveillance system the recorded video clip requested. In this way, a portion of the continuous real-time surveillance video feed as noted above (see, step 102) will be used to analyze the ensuing law enforcement encounter for any civil rights violation(s) and/or unprofessional or unethical conduct. Illustratively, the specified duration for such recorded video clip may be in the range of five (5) to ten (10) minutes prior to the detected law enforcement encounter but any other specified duration may be utilized to match a particular application. At step 114, triggering a start of a real-time law enforcement video recording associated with the detected law enforcement encounter, and at step 116, responsive to the triggering of the start of the real-time law enforcement video recording, monitoring the law enforcement encounter by the AI-based surveillance system aboard the transportation article using a second plurality of data collected by the plurality of surveillance devices during a time period associated with the law enforcement encounter. In an embodiment, the plurality of surveillance devices are located both within the transportation article and external to the transportation article in order to capture relevant video angles and audio fields for documenting the law enforcement encounter. Illustratively, object detection algorithms may be used to perform such monitoring activities including, but not limited to, convolutional neural networks (R-CNN, Region-Based Convolutional Neural Networks), Fast R-CNN, and YOLO (You Only Look Once). Further, other AI algorithms including, but not limited to, GPT-4 and GPT-40 may also be used for analyzing the recorded law enforcement encounters. At step 118, accessing and analyzing by the AI-based surveillance system at least one legal database and retrieving therefrom one or more applicable laws, regulations or ordinances governing the law enforcement encounter, and at step 120, providing by the AI-based surveillance system, using the one or more applicable laws, regulations or ordinances governing the law enforcement encounter accessed and analyzed, to at least one occupant within the transportation article a legal synopsis of their individual legal rights. For example, in the United States, law enforcement must have a bona fide reason or cause to initiate a law enforcement encounter (e.g., probable cause, observing a traffic violation, suspicious activity, drunk driving, etc.) In an embodiment, the legal synopsis provided contains at least one civil rights violation with respect to one or more occupants in the transportation article. Importantly, the operations and analysis provided by the AI-based surveillance system may be useful not only in protecting an individual's civil liberties but also provide protection to their physical assets (e.g., their car or physical contents therein). Illustratively, one or more web data extraction tools may be used to facilitate the search including, but not limited to, any one of well-known algorithms used to perform web extraction including, but not limited to, Bright Data, Oxylabs Scraper API, Webscrper.io, Apify, Scrape.do, ParseHub, Diffbot, Scrape-It.Cloud, Octoparse, ScrapingBee, Scarpingdog, Grepsr, Sraper API, Srapy, and Import.io. In an embodiment, a search query of the at least one legal database is initiated by the AI-surveillance system directed to one or more applicable laws, regulations or ordinances governing the law enforcement encounter. In an embodiment, all or a portion of the legal database is stored locally in a memory device associated with the AI-based surveillance system. In another aspect, responsive to analyzing the real-time law enforcement video recording during the time period associated with the law enforcement encounter, the AI-based surveillance system may provide extemporaneous guidance to the individual involved in the law enforcement encounter. Such guidance may or may not include the legal synopsis and may be less formal in nature. In this way, the AI-based surveillance system may intervene on behalf of the individual involved in the law enforcement encounter (e.g., if that individual becomes nervous or flustered and/or cannot formulate questions to ask). For example, based on analyzing the real-time law enforcement video recording the AI-based surveillance system may direct the individual not to answer a question posed to them or provide a formulated to ask the law enforcement officer. In such an embodiment, the need for accessing a legal database and/or formulating a legal analysis may not be required thereby making steps 118 and 120 optional in nature.

At step 122, determining if the occupant(s) of the transportation article have any questions and if so, at step 124, receiving by the AI-based surveillance system one or more occupant questions and analyzing by the AI-based surveillance system, at step 126, the one or more occupant questions received and transmitting one or more answers thereto to the at least one occupant. Illustratively, a large language model (LLM) may be employed to facilitate such question and answer functionality. For example, some notable LLMs are OpenAI's GPT series of models (e.g., GPT-3.5, GPT-4 and GPT-40; used in ChatGPT and Microsoft Copilot). Google's Gemini, Meta's LLAMA family of models. Anthropic's Claude models, and Mistral AI's models. At step 128, detecting by the AI-based surveillance system an end to the law enforcement encounter, and at step 130, responsive to the detection of the end of the law enforcement encounter, triggering an end to the real-time law enforcement video recording. In an embodiment, one or more AI agents may be utilized to interact with the environment (e.g., the law enforcement encounter) and perform the necessary tasks in assisting with the delivery of monitoring and protecting an individual's civil rights and assets during the law enforcement encounter or emergency services encounter using AI-based surveillance in accordance with the principles of the disclosed embodiments. For example, the AI agent may configured as a model-based reflex agent such that the AI agent is able to consider a current location and the effects of the action(s) necessary in the course of the law enforcement encounter being monitored. Of course, this is one of various AI agents that may be used which include, but are not limited to, simple reflex agents, goal-based agents, and learning agents. At step 132, storing a record associated with the law enforcement encounter. In an embodiment, the real-time law enforcement video recording associated with the detected law enforcement encounter is transmitted to and stored by a cloud-based database. Alternatively, in an embodiment, the real-time law enforcement video recording is stored locally by AI-based surveillance system. At step 134, determining if monitoring is to continue and if so, at step 136 returning to step 102, otherwise the operations end.

Continuing at steps 106 and 108, responsive to a detection of an occurrence of an emergency services encounter proximate to the transportation article, at step 138, sensing by one or more of the plurality of surveillance devices a make-way signal initiated by and associated with the emergency services encounter. For example, an emergency vehicle such as an ambulance or firetruck may be detected at some distance behind the transportation article with sirens and flashing lights. At step 140, responsive to the make-way signal sensed, confirming by the AI-based surveillance system using a third plurality of data collected by the plurality of surveillance devices at least one emergency vehicle is approaching the transportation article, and at step 142, transmitting to a controlling body of the transportation article an emergency yield command to initiate moving the transportation article to a position clear of the approaching at least one emergency vehicle. At step 144, determining if monitoring is to continue and then returning to step 102, otherwise the operations end.

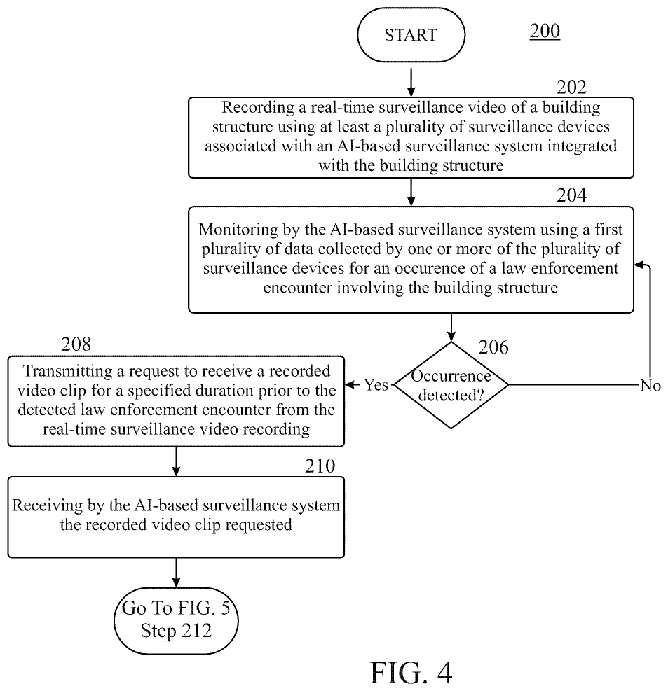

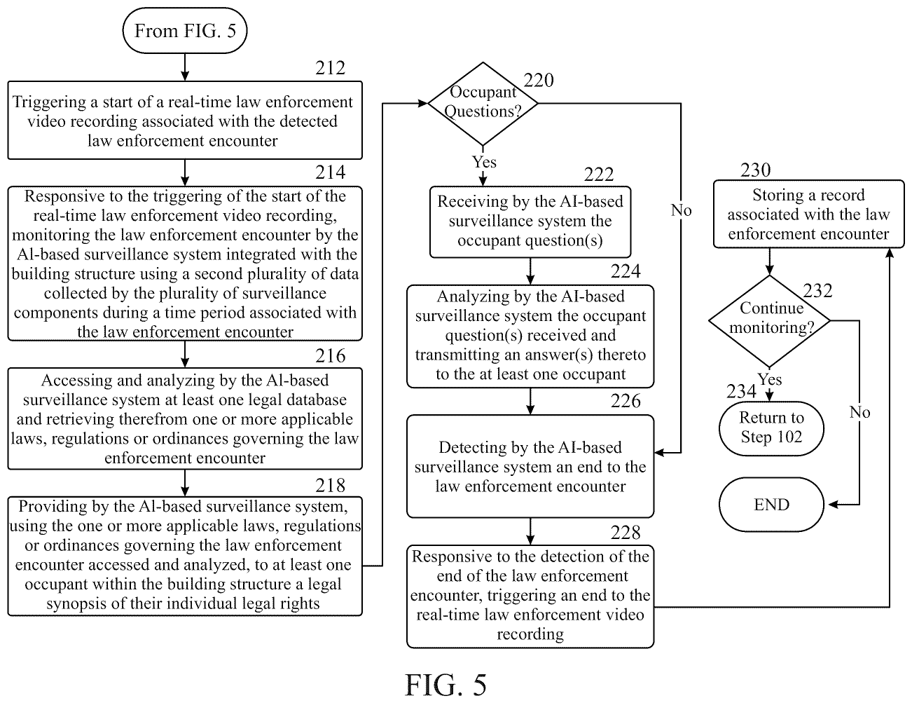

Turning our attention to FIGS. 4 and 5, a flowchart of illustrative operations 200 is shown for monitoring and protecting an individual's civil rights and assets during a law enforcement encounter involving a building structure using AI-based surveillance in accordance with an embodiment. More particularly, at step 202, recording a real-time surveillance video of the transportation article using at least an AI-based surveillance system comprising at least an AI-based surveillance controller in combination with the plurality of surveillance devices integrated with the building structure (e.g., an individual's home or place of business). At step 204, monitoring by the AI-based surveillance system using a first plurality of data collected by one or more of the plurality of surveillance devices for an occurrence of a law enforcement encounter involving the building structure. At step 206, responsive to a detection of an occurrence of a law enforcement encounter involving the building structure, at step 208, transmitting a request to receive a recorded video clip for a specified duration prior to the detected law enforcement encounter from the real-time surveillance video recording. At step 210, receiving by the AI-based surveillance system the recorded video clip requested, and at step 212, triggering a start of a real-time law enforcement video recording associated with the detected law enforcement encounter. At step 214, responsive to the triggering of the start of the real-time law enforcement video recording, monitoring the law enforcement encounter by the AI-based surveillance system integrated with the building structure using a second plurality of data collected by the plurality of surveillance devices during a time period associated with the law enforcement encounter. In an embodiment, the plurality of surveillance devices are located both within the building structure and external to the building structure in order to capture relevant video angles and audio fields for documenting the law enforcement encounter. At step 216, accessing and analyzing by the AI-based surveillance system at least one legal database and retrieving therefrom one or more applicable laws, regulations or ordinances governing the law enforcement encounter and at step 218, providing by the AI-based surveillance system, using the one or more applicable laws, regulations or ordinances governing the law enforcement encounter accessed and analyzed, to at least one occupant within or around the building structure a legal synopsis of their individual legal rights. In another aspect, responsive to analyzing the real-time law enforcement video recording during the time period associated with the law enforcement encounter, the AI-based surveillance system may provide extemporaneous guidance to the individual involved in the law enforcement encounter. Such guidance may or may not include the legal synopsis and may be less formal in nature. In this way, the AI-based surveillance system may intervene on behalf of the individual involved in the law enforcement encounter (e.g., if that individual becomes nervous or flustered and/or cannot formulate questions to ask). In this further aspect, the need for accessing a legal database and/or formulating a legal analysis may not be required thereby making steps 216 and 218 optional in nature. At step 220, determining if an occupant has any questions, and if so, at step 222, receiving by the AI-based surveillance system one or more occupant questions. At step 224, analyzing by the AI-based surveillance system the one or more occupant questions received and transmitting one or more answers thereto to the at least one occupant. As noted previously, the operations and analysis provided by the AI-based surveillance system may be useful not only in protecting an individual's civil liberties but also provide protection to their physical assets (e.g., their home or property). At step 226, detecting by the AI-based surveillance system an end to the law enforcement encounter and at step 228, responsive to the detection of the end of the law enforcement encounter, triggering an end to the real-time law enforcement video recording. At step 230, storing a record associated with the law enforcement encounter. At step 232, determining if monitoring is to continue then at step 234, returning to step 102, otherwise the operations end.

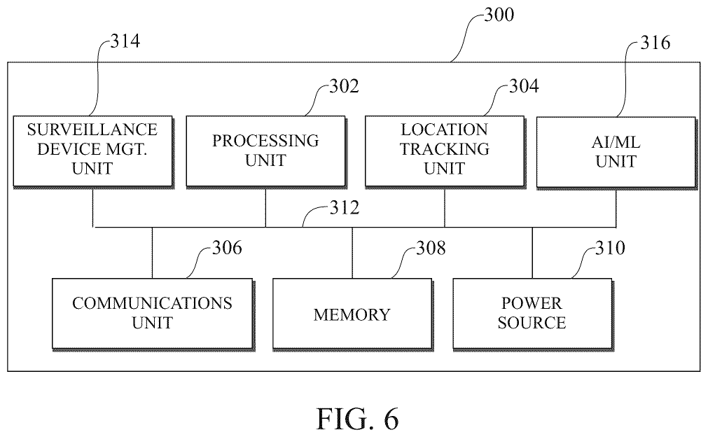

Turning our attention to FIG. 6, a high-level block diagram is shown of an AI-based surveillance system controller 300 in accordance with an embodiment. More particularly, the AI-based surveillance system controller 300 may be controlled and operated using processing unit 302 which may comprise one or more processors (including an AI processor), location tracking unit 304, communications unit 306, memory 308, power source 310, surveillance device management unit 314, artificial intelligence (AI)/machine learning (ML) unit 316 and bus 312. In accordance with the disclosed embodiments, the AI-based surveillance system controller 300 may configured and arrange to be mounted on or within the transportation article and/or the building structure as discussed throughout this disclosure. The processing unit 302 may be used for executing program code (e.g., the AI-based civil rights and asset protection app 800) and communications unit 306 for managing communications to and from the AI-based surveillance system controller 300. The memory 308 may be used for storing program code and data and coupled to the bus 312 for storing computer-readable instructions to be executed by the processing unit 302. The processing unit 302 and/or AI/ML unit 316 may include both general and special purpose microprocessors (e.g., an AI processor) and may be the sole processor or one of multiple processors of the device. Further, the processing unit 302 may comprise one or more central processing units (CPUs) and may include, be supplemented by, or incorporated in, one or more application-specific integrated circuits (ASICs) and/or one or more field programmable gate arrays (FPGAs). The AI/ML unit 316 will support the various AI algorithms necessary or useful to execute the AI-based surveillance operations and features detailed throughout this disclosure. The memory 308 may also be utilized for storing temporary variables or other intermediate information during the execution of the instructions by the processing unit 302. The memory 308 may include storage devices, such as a magnetic, optical, or solid-state devices that may be coupled to the bus 312 for storing information and instructions. The memory 308 may comprise a non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as read-only memory (ROM), erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices. The surveillance device management unit 314 may be used to coordinate and manage communications with the plurality of surveillance devices necessary or useful to execute the AI-based surveillance operations and features detailed throughout this disclosure. The locating tracking unit 304 may be used to facilitate the delivery of location-based services (e.g., Global Position System (GPS) tracking) and registering the exact real-time geographic location of the AI-based surveillance system controller 300.

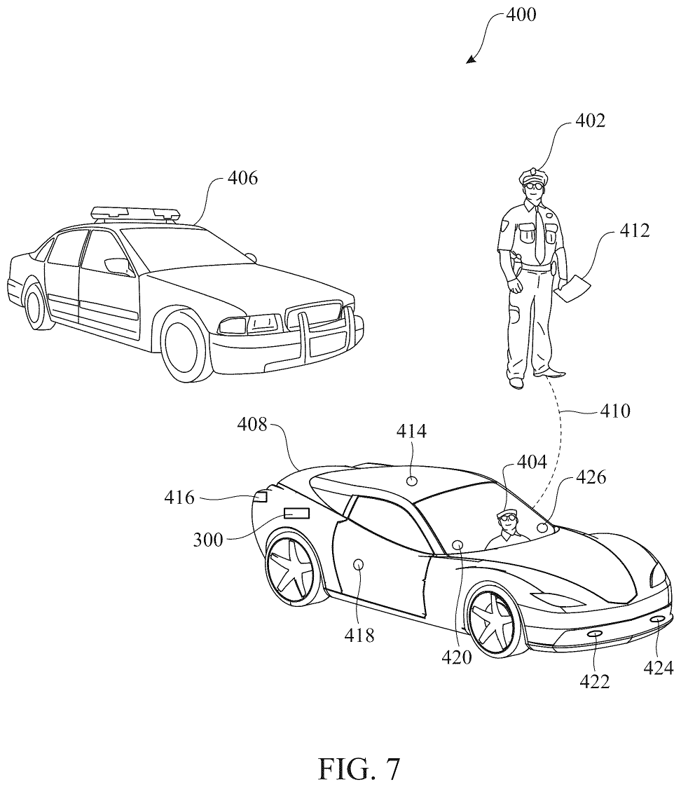

Turning our attention to FIG. 7, an illustrative law enforcement encounter 400 is shown in accordance with an embodiment between law enforcement officer 402 and civilian 404. Illustratively, the law enforcement officer 402 (e.g., a police officer) employing law enforcement vehicle 406 has pulled the civilian 404 over while operating transportation article 408 (e.g., a passenger car with a driver or a self-driving vehicle). The transportation article 408 is configured with the AI-based surveillance system comprising at least AI-based surveillance system controller 300 (e.g., mounted in rear trunk area of the transportation vehicle 408) and a plurality of surveillance devices comprised by surveillance device 414, surveillance device 416, surveillance device 418, surveillance device 420, surveillance device 422, surveillance device 424, and surveillance device 426. As noted previously, these surveillance devices may comprise at least one or more cameras, microphones, communications devices, and location-tracking GPS devices. As will be appreciated, the placement of the plurality of surveillance devices on the roof, door panel, side panel, front grille/bumper, and windshield is not limited to these areas shown in FIG. 7 but may be any practical or convenient location inside and/or outside of the transportation vehicle 408 that will facilitate capturing relevant video angles and audio fields for documenting the law enforcement encounter 400. For example, as the law enforcement officer 402 approaches 410 the transportation article 408 (e.g., in order to issue moving vehicle summons 412) the plurality of surveillance devices 414-426 will continue capturing real-time audio and video feeds for the operations and analysis provided by the AI-based surveillance system in protecting an individual's civil liberties but also provide protection to their physical assets (e.g., in this case, the transportation article 408) as detailed herein.

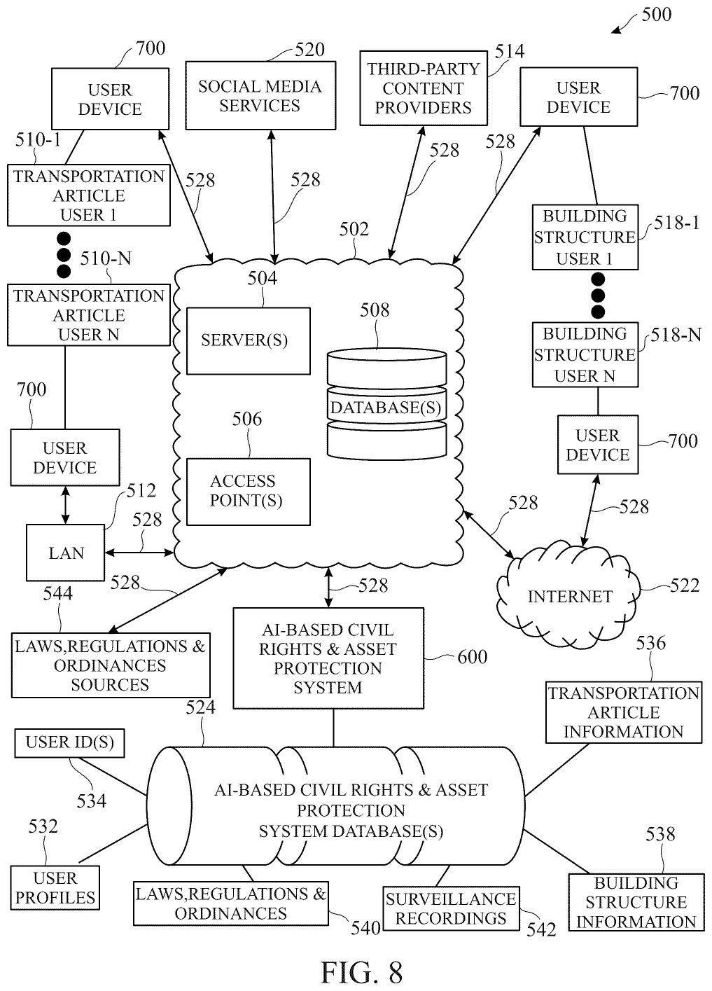

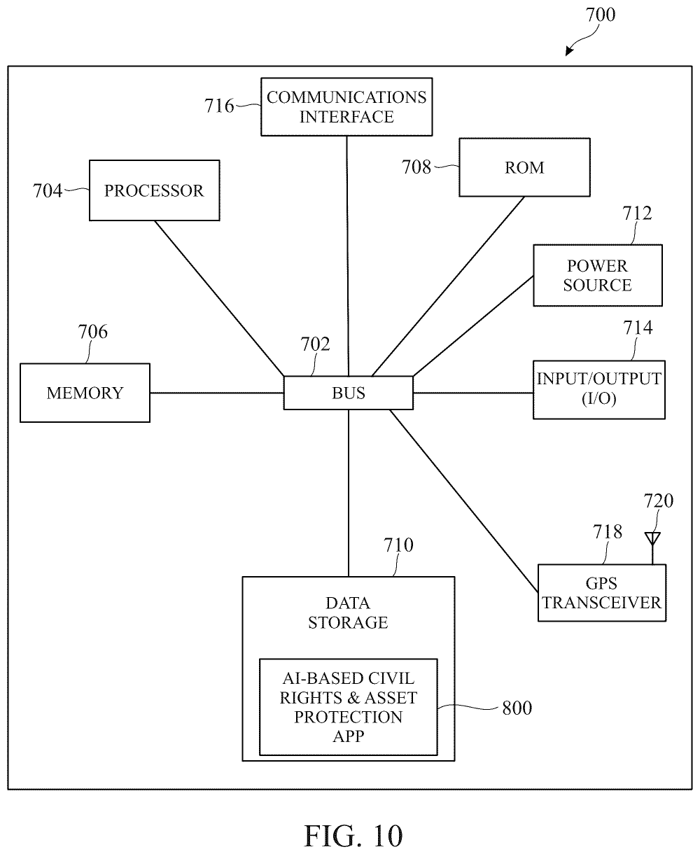

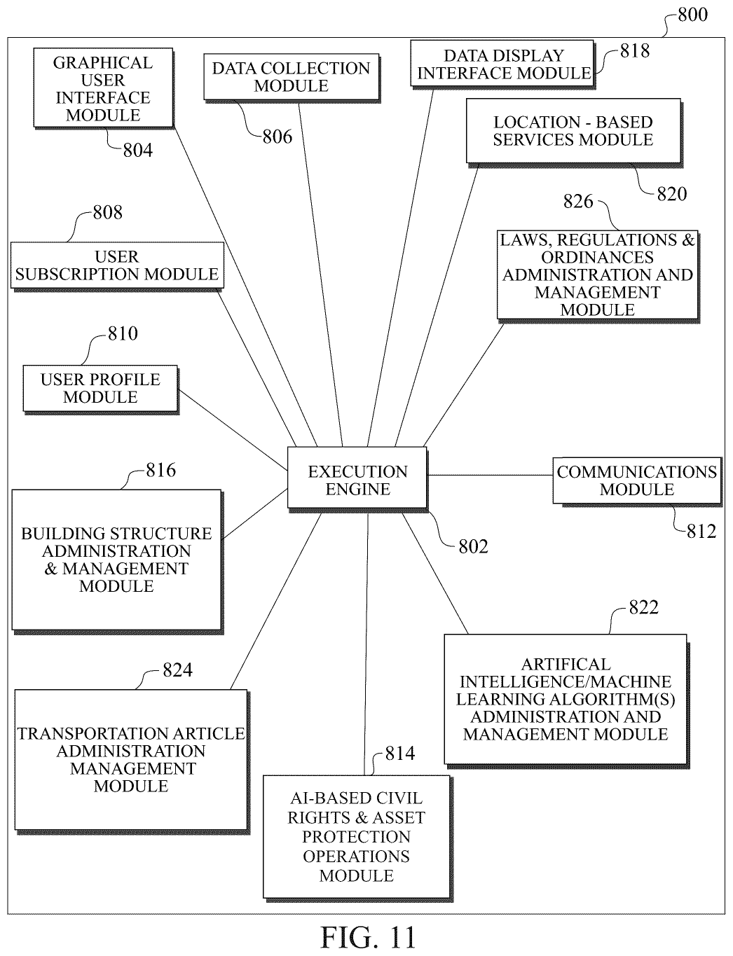

FIG. 8 presents a high-level block diagram of a cloud network services architecture 500 supporting an AI-based surveillance system in accordance with an embodiment. As shown for instance in FIG. 8, the cloud network services architecture 500 includes a cloud 502 comprising at least server(s) 504, access point(s) 506 and database(s) 508. As will be detailed herein below, the cloud 502 facilitates the delivery of the AI-based surveillance services using the AI-based surveillance system which may be in communication with the AI-based civil rights and asset protection system 600 in an embodiment to a plurality of users (e.g., the plurality users comprised by transportation article user 1 110-1 through transportation article user N 110-N, and/or building structure user 1 118-1 through building structure user N 118-N). Illustratively, the transportation article user 1 110-1 through transportation article user N 110-N are civilian users and members of the general public. In an embodiment, the AI-based surveillance services processing, offered by and through the cloud network services architecture 500 will be facilitated by the AI-based civil rights and asset protection app 800 app (see, FIG. 11), as will be detailed herein below, executing on a user device 700 (see, FIG. 10) and/or the AI-based civil rights and asset protection system 600. The user device 700 provides the various users (e.g., transportation article user 1 110-1, transportation article user N 110-N, building structure user 1 118-1, and/or building structure user N 118-N) with real-time access to AI-based surveillance services in accordance with the disclosed embodiments herein.

As noted above, the cloud 502 comprises at least server(s) 504, the access point(s) 506 and the database(s) 508. Cloud, cloud service, cloud server and cloud database are broad terms and are to be given their ordinary and customary meaning to one of ordinary skill in the art and includes, without limitation, any database, data repository or storage media which store content typically associated with and managed by users, law enforcement communities, laws, regulations and ordinances sources (e.g., laws, regulations and ordinances sources 544), social media services (e.g., social media services 520) and third-party content providers (e.g., third-party content providers 514) in the context of law enforcement activities and services, to name just a few. A cloud service may include one or more cloud servers and cloud databases that provides for the remote storage of content as hosted by a third-party service provider or operator. A cloud server may include an HTTP/HTTPS server sending and receiving messages in order to provide web-browsing interfaces to client web browsers as well as web services to send data to integrate with other interfaces (e.g., as executed on the user device 700). The cloud server may be implemented in one or more servers and may send and receive content in a various forms and formats, user supplied and/or created information/content and profile/configuration data that may be transferred from or stored in a cloud database (e.g., the database(s) 508).

A cloud database may include one or more physical servers, databases or storage devices as dictated by the cloud service's storage requirements. The cloud database may further include one or more well-known databases (e.g., an SQL database) or a fixed content storage system to store content, user profile information, configuration information, administration information and any other information necessary to execute the cloud service. In various embodiments, one or more networks providing computing infrastructure on behalf of one or more users may be referred to as a cloud, and resources may include, without limitation, data center resources, applications (e.g., software-as-a-service or platform-as-a-service) and management tools.

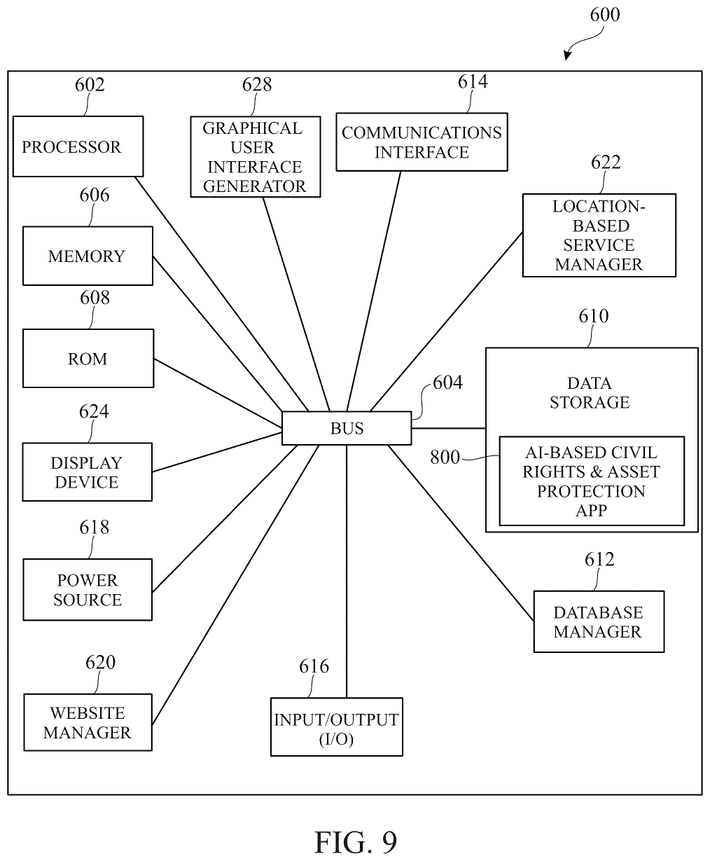

Turning our attention to FIG. 9, an illustrative configuration for the AI-based civil rights and asset protection system 600 is shown for deployment in the cloud network services architecture 500 in accordance with an embodiment. As shown, the AI-based civil rights and asset protection system 600 comprises processor 602 for executing program code (e.g., AI-based civil rights and asset protection app 800) and communications interface 614 for managing communications to and from the AI-based civil rights and asset protection system 600, memory 606 and/or read-only memory (ROM) 608 for storing program code and data, and power source 618 for powering the AI-based civil rights and asset protection system 600. The memory 606 is coupled to the bus 604 for storing computer-readable instructions to be executed by the processor 602 (e.g., execution of the AI-based civil rights and asset protection app 800). Database manager 612 is used to manage the delivery and storage of content, data, and other information in the AI-based civil rights and asset protection system database(s) 524, database(s) 508 and across third-party content providers, for example. The AI-based civil rights and asset protection system database(s) 524 may store and provide information including, but not limited, to user profiles 532, user IDs 534, transportation article information 536, building structure information 538, laws, regulations and ordinances 540, and surveillance recordings 542. As noted previously, in an embodiment, the operations performed by for the AI-based civil rights and asset protection system 600 in combination with the AI-based civil rights and asset protection app 800 and the AI-based surveillance system embedded in a transportation article and/or building structure provide for the real-time access to AI-based surveillance services in accordance with the disclosed embodiments herein.

Website manager 620 is used to deliver and manage content, data, and other information across one or more websites that may be utilized to access and use the AI-based civil rights and asset protection system 600, for example. Further, the operations provided by and through the AI-based civil rights and asset protection app 800 may be offered through a web-based application. As will be discussed in greater detail herein below, the AI-based civil rights and asset protection app 800, as stored in data storage 610, when executed by the processor 602 will enable access by a plurality of parties (e.g., transportation article user 1 110-1 through transportation article user N 110-N and/or building structure user 1 118-1 through building structure user N 118-N) to the AI-based civil rights and asset protection system 600 for the processing of, for example, the user profiles 532, user IDs 534, transportation article information 536, building structure information 538, laws, regulations and ordinances 540, and surveillance recordings 542. Location-based service manager 622 facilitates the delivery of location-based services (e.g., GPS tracking) either independently or on user device 700 thereby allowing the AI-based civil rights and asset protection system 600 to register the exact location of the user of the user device 700, for example, as the transportation article user 1 510-1 drives from one location to another location such that the services offered via the AI-based surveillance processing hereunder may be tailored to a current location and/or the needs of the user may change based on their current location and a particular law enforcement encounter.

In an embodiment, the AI-based surveillance processing provided through the execution of the AI-based civil rights and asset protection app 800 may also include a web-based delivery platform and/or accessing and interfacing any number of websites using website manager 620 for procuring information and data that can be used in the AI-based civil rights and asset protection system 600. The term “website” in the context herein is used in a conventional and broadest sense and is located on at least one server containing web pages stored thereon and is operational in a 24-hour/7-day typical fashion. Further, as shown in the cloud network services architecture 500, the plurality of parties (i.e., transportation article user 1 110 through transportation article user N 110-N and/or building structure user 1 118-1 through building structure user N 118-N) may alternatively utilize well-known Internet 522 for access to the AI-based civil rights and asset protection system 600 by and through a web browser on the user device 700, for example. The AI-based civil rights and asset protection system 600 may also include one or more input/output devices 616 that enable user interaction with the AI-based civil rights and asset protection system 600 (e.g., camera, display, keyboard, mouse, speakers, microphone, buttons, etc.). The input/output devices may include peripherals, such as an NFC device (e.g., NFC tag reader), camera, printer, scanner (e.g., a QR-code scanner), touchscreen display, etc. For example, the input/output devices 616 may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the AI-based civil rights and asset protection system 600 or an associated display device 624, for example, that may also be managed by graphical user interface generator 628.

The communications interface 614 is used to facilitate communications across the communications links 528 (see, FIG. 8) within the cloud network services architecture 500. This may take the form, for example, of a wide area network connection that communicatively couples the AI-based civil rights and asset protection system 600 with the access points 506 (see, FIG. 1) which may be a cellular communications service. Similarly, communications managed by the communications interface 614 may take the form, for example, of a local Wi-Fi network interface or Ethernet interface the communicatively couples the AI-based civil rights and asset protection system 600 with the Internet 522, local area network (LAN) 512, and ultimately the user devices 700. In the instant embodiment, the AI-based civil rights and asset protection app 800 and/or the communications interface 614 may include a communications stack for facilitating communications over the respective communications link 528. Electronic communications by and through AI-based civil rights and asset protection system 600 between the various systems, networks, devices, users, entities, and/or individuals are facilitated by the communications links 528 in accordance with any number of well-known communications protocols and methods (e.g., wireless communications).

Turning our attention briefly to FIG. 10, an illustrative user device 700 configured in accordance with an embodiment. The user device 700 typically includes bus 702 and processor 704 coupled to the bus 702 for executing operations and processing information. As will be appreciated, a “user device” in the context herein may comprise a wide variety of devices such as any type of hardware device, mobile devices, smartphones, laptop computers, desktop computers, tablets, artificial reality glasses, augmented reality (AR) glasses, smart glasses, and wearables, to name just a few, that execute applications (e.g., a mobile application) in accordance with the principles of the disclosed embodiments herein. For example, the execution of the AI-based civil rights and asset protection app 800 will be discussed in much greater detail herein below. The processor 704, as powered by power source 712, may include both general and special purpose microprocessors, and may be the sole processor or one of multiple processors of the device. This is equally applicable to the processor 602 of FIG. 9. Further, the processor 704 (or the processor 602) may comprise one or more central processing units (CPUs) and may include, be supplemented by, or incorporated in, one or more application-specific integrated circuits (ASICs) and/or one or more field programmable gate arrays (FPGAs).

The user device 700 may also include memory 706 coupled to the bus 702 for storing computer-readable instructions to be executed by the processor 704. The memory 706 may also be utilized for storing temporary variables or other intermediate information during the execution of the instructions by the processor 704. The user device 700 may also include ROM 708 or other static storage device coupled to the bus 702. Further, data storage device 710, such as a magnetic, optical, or solid-state device may be coupled to the bus 702 for storing information and instructions for the processor 704 including, but not limited to, the AI-based civil rights and asset protection app 800. Data storage device 710 (or the data storage device 610) and the memory 706 (and the memory 606) may each comprise a non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

The user device 700 may also include one or more communications interface 716 for communicating with other devices via a network (e.g., a wireless communications network) or communications protocol (e.g., Bluetooth®). For example, such communication interfaces may be a receiver, transceiver, or modem for exchanging wired or wireless communications in any number of well-known fashions. For example, the communications interface 716 (or the communications interface 614) may be an integrated services digital network (ISDN) card or modem/router used to facilitate data communications of various well-known types and formats. Further, illustratively, the communications interface 716 (or the communications interface 614) may be a LAN card used to provide data communication connectivity to a comparable LAN. Wireless communication links may also be implemented. The Global Positioning System (GPS) transceiver 718 and antenna 720 facilitate delivery of location-based services in order to register the exact location of the user device 700, for example, as the user roams from one location to another location. As will be understood, the application herein will be able to track individual users and their location upon the launching of the application thereby enabling the well understood GPS location features of the user device 700 (e.g., a smartphone).

As will be appreciated, the functionality of the communication interface 716 (or the communications interface 614) is to send and receive a variety of signals (e.g., electrical, optical, or other signals) that transmit data streams representing various data types. The user device 700 may also include one or more input/output devices 714 that enable user interaction with the user device 700 such as a camera, display, keyboard, mouse, speakers, microphone, buttons, etc. The input/output devices 714 (or I/O devices 616) may include peripherals, such as an NFC device (e.g., NFC reader), camera, printer, scanner (e.g., QR-code scanner), touchscreen display, etc. For example, the input/output devices 714 (or the I/O devices 616) may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 700 or an associated display device, for example.

Turning our attention to FIG. 11, an illustrative architecture for the operation of the AI-based civil rights and asset protection app 800 is presented in accordance with an embodiment. As will be appreciated, the architecture may be used, illustratively, in conjunction with the cloud network services architecture 500, the AI-based civil rights and assets protection system 600, and/or the user device 700 for launching and executing the AI-based civil rights and asset protection app 800 and its associated operations. As shown, the architecture for the operations of the AI-based civil rights and asset protection app 800 provides several interfaces and engines used to perform a variety of functions such as the collection, aggregation, manipulation, processing, analyzing, verification, authentication, and display of applicable real-time information and data that are useful to realize the delivery of the AI-based surveillance operations of the disclosed embodiments. Data display interface module 818 and communications module 812 are used to facilitate the input/output and display of electronic data and other information to, illustratively, the users (e.g., transportation article user 1 110-1 through transportation article user N 110-N) employing the user device 700 (e.g., a touch screen of the user device 700) and executing the AI-based civil rights and asset protection app 800. The data collection module 806 facilitates data gathering from the plurality of users and other third parties. The location-based services module 820 provides for the delivery of location-based services in order for the geographic locations of the users to be identified and displayed (e.g., GPS locations), as detailed above. The communications module 812 will also facilitate communications by and through the AI-based civil rights and asset protection system 600, for example.

Execution engine 802 may be employed to deliver the AI-based surveillance services herein through the execution of the AI-based civil rights and asset protection app 800. In such delivery, the execution engine 802 will operate and execute, as detailed herein, with at least the following program modules: graphical user interface module 804, data collection module 806, user subscription module 808, user profile module 810, communications module 812, AI-based civil rights and asset protection operations module 814, building structure administration and management module 816, data display interface module 818, artificial intelligence/machine learning algorithm(s) administration and management module 822, transportation article administration and management module 824, and laws, regulations and ordinances administration and management module 826. The operations executed by the foregoing modules are, for example, as discussed throughout this disclosure.

In a further embodiment, a method is provided for monitoring and protecting an individual's civil rights and assets during an encounter involving another individual using AI-based surveillance where both individuals are civilians and not affiliated with any official governmental agency or authority. The method comprising: (i) recording a real-time surveillance video of a first individual using at least an AI-based surveillance system comprising at least an AI-based surveillance controller in combination with the plurality of surveillance devices; (ii) monitoring by the AI-based surveillance system using a first plurality of data collected by one or more of the plurality of surveillance devices for an occurrence of an encounter involving the first individual and a second individual; (iii) responsive to a detection of an occurrence of the encounter: (a) transmitting a request to receive a recorded video clip for a specified duration prior to the detected encounter from the real-time surveillance video recording; (b) receiving by the AI-based surveillance system the recorded video clip requested; (c) triggering a start of a real-time encounter video recording associated with the detected encounter; (d) responsive to the triggering of the start of the real-time encounter video recording, monitoring the encounter by the AI-based surveillance system using a second plurality of data collected by the plurality of surveillance devices during a time period associated with the encounter; (c) accessing and analyzing by the AI-based surveillance system at least one legal database and retrieving therefrom one or more applicable laws, regulations or ordinances governing the encounter; (f) providing by the AI-based surveillance system, using the one or more applicable laws, regulations or ordinances governing the encounter accessed and analyzed, to the first individual a legal synopsis of their individual legal rights and/or other guidance with respect to the encounter; (g) receiving by the AI-based surveillance system one or more questions from the first individual; (h) analyzing by the AI-based surveillance system the one or more questions received and transmitting one or more answers thereto to the first individual; (i) detecting by the AI-based surveillance system an end to the encounter; (j) responsive to the detection of the end of the encounter, triggering an end to the real-time encounter video recording; and (k) storing a record associated with the encounter. In this way, the principles of the disclosed embodiments may apply equally to interactions between two civilians to protect one of the civilians from any nefarious or other deleterious actions of the other civilian. For example, in a situation where an individual is travelling aboard and is unfamiliar with the local laws, regulations, and customs, or in a situation where an individual is being subjected to a fraud, intimidation practices and/or coercive behavior.

Those skilled in the art will appreciate that the present disclosure contemplates the use of systems configurations and/or computer instructions that may perform any or all of the operations involved in the AI-based surveillance features herein. The disclosure of computer instructions that include, for example, the AI-based civil rights and asset protection app 800 and the AI-based civil rights and asset protection system 600 instructions is not meant to be limiting in any way. Those skilled in the art will readily appreciate that stored computer instructions and/or systems configurations may be configured in any way while still accomplishing the various goals, features, and advantages according to the present disclosure. The terms “program,” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system. Accordingly, the applications hereunder may be written using any number of programming languages and/or executed on compatible platforms including, but not limited to, JavaScript, PHP (PHP: Hypertext Preprocessor), WordPress, Drupal, Laravel, Python, React.js (ReactJS/React Native), Angular.js, and Vue.js. Computer readable program instructions for carrying out operations of the disclosed embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (e.g., using an Internet Service Provider), or the connection may be made to external computers.

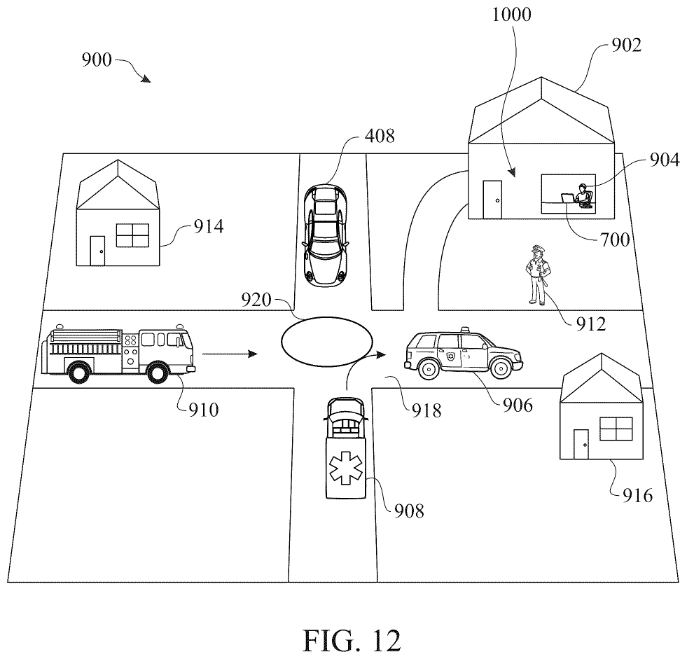

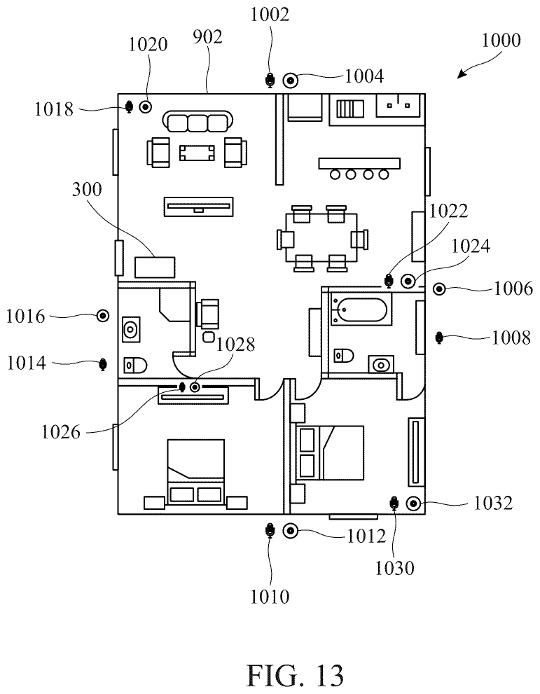

Turning our attention to FIGS. 12 and 13, a diagram 900 of an illustrative law enforcement encounter involving a building structure in accordance with an embodiment, and FIG. 11 presents a diagram of AI-based system layout 1000 with respect to a building structure configured with an AI-based surveillance system in accordance with an embodiment. Illustratively, the law enforcement encounter is shown in accordance with an embodiment between law enforcement officer 912 and civilian 904 residing in building structure 902 (e.g., a single family residential home) in a residential neighborhood that includes other homes 914 and 916, for example. Illustratively, the law enforcement officer 912 (e.g., a police officer) employing law enforcement vehicle 906 has arrived at the location to serve the civilian 904 with some form of summons or other legal document (not shown). The building structure 902 is configured in accordance with the AI-based system layout 1000 as shown in detail in FIG. 13 comprising at least AI-based surveillance system controller 300 (e.g., installed in an interior room of the building structure 902) and a plurality of surveillance devices located internal to and external to the building structure 902 comprised by surveillance device 1002, surveillance device 1004, surveillance device 1006, surveillance device 1008, surveillance device 1010, surveillance device 1012, surveillance device 1014, surveillance device 1016, surveillance device 1018, surveillance device 1020, surveillance device 1022, surveillance device 1024, surveillance device 1026, surveillance device 1028, surveillance device 1030, and surveillance device 1032. In an embodiment, the AI-based surveillance system may be configured such that the AI-based surveillance system controller 300 and the associated surveillance devices may be integrated and interfaced with a home security system installed in building structure 902. As noted previously, these surveillance devices may comprise at least one or more cameras, microphones, communications devices, and location-tracking GPS devices. As will be appreciated, the placement of the plurality of surveillance devices on the interior and the exterior is not limited to these areas shown in FIG. 11 but may be any practical or convenient location inside and/or outside of the building structure 902 that will facilitate capturing relevant video angles and audio fields for documenting the law enforcement encounter, as detailed previously. For example, as the law enforcement officer 912 approaches the building structure 902 the plurality of surveillance devices 1002-1032 will continue capturing real-time audio and video feeds for the operations and analysis provided by the AI-based surveillance system in protecting an individual's civil liberties but also provide protection to their physical assets (e.g., in this case, the building structure 902 and its surrounding property) as detailed herein. Of course, in the event an emergency services encounter 920 is also transpiring, then the transportation article 408 will receive an alert from the AI-based system configured thereon to “make way” for firetruck 910 and/or ambulance 908.

In an embodiment, one or more of the individuals (e.g., the law enforcement officer 912 and/or the civilian 904; see also FIG. 7 law enforcement officer 402 and/or the civilian 404) involved with the law enforcement encounter and/or the emergency services encounter (e.g., the emergency services encounter 920) may employ one or more AR devices, in the course of monitoring and protecting an individual's civil rights and assets during a law enforcement encounter or emergency services encounter using AI-based surveillance in accordance with the principles of the disclosed embodiments. Virtual reality (VR) or augmented reality (AR) environments have existed for a number of years. VR or AR may refer to simulated environments featuring computer graphics that a user can interact with in a way that is more immersive than merely watching a television or computer screen. Past VR environments have included large pod-like or cockpit-like stations, where a user would sit down inside the station and be able to interact with a panoramic graphical interface that represented some 3-dimensional world. The user would typically utilize some external set of controllers, such as a joystick or interactive glove, in order to move around in the VR environment. Other implementations of VR have included VR goggles, which are head-mounted devices that a user only needs to wear over their eyes. The user can then see the equivalent of a panoramic view that they could have seen in the immersive, pod-like stations, but the goggles enable the user to be more mobile and does not require such a large hardware implementation. The user may manipulate the environment seen through the goggles by using some external device, like a joystick or some other controller. AR implementations attempt to blend computer graphics and other images with a user's actual surroundings, such that the user may perceive that their surroundings have been augmented. To achieve this, AR smart eyeglasses that the user may wear typically provide transparent or substantially transparent lenses, so that the user can still see their actual surroundings while viewing other objects at the same time. Companies such as Apple, Google, Microsoft, Qualcomm, Epson, Nreal, Rokid, and Lenovo market a variety of AR hardware devices. Other companies such as Apple and Meta have also announced work in the area of AR hardware devices. Modern day smartphones may also include AR capability via their camera systems, allowing the user to point the device at their surroundings and then data overlays occur via their smartphone screen, offering AR capabilities similar to the AR smart eyeglasses.

Augmented reality technology involves modifying a view of a real-world environment (also referred to as a “scene”) to enhance the viewer's perception. This can be done, for example, by presenting various AR elements to a user such that the AR elements are incorporated into the user's experience of a scene. By incorporating these AR elements, the user's experience of the scene may thereby become enhanced. Examples of these AR elements include computer-generated data, text, images, sounds, haptics, and the like. AR technology may take the form of electronic devices, including wearable devices (e.g., smart eyeglasses), mobile devices (e.g., smartphones), tablets, or laptop computers. These AR devices may perform a variety of AR functions. For example, a pair of smart eyeglasses may include a transparent display capable of presenting various visual AR elements. When a user wears the smart eyeglasses, the display may be positioned in between the user's eyes and the scene that the user is viewing. In this way, the AR elements presented on the display of the smart eyeglasses may be overlaid on top of and/or incorporated into the user's view of the scene. AR can use “markers” or data-based triggers, for instance geolocation, to know where to include AR elements in the user's display. By providing these AR functionalities, AR devices may facilitate social interactions. For example, an AR device may display biographical information about various people that a user might encounter. An AR device may use markers/geolocation or scan a person's face, determine identification information related to the person, and thereafter display some data about that person, such as his name, profession, age, interests, and/or contact information.

In mixed reality (MR), digital and real-world objects are co-existing and may interact with each other in real-time. This immersive technology (sometimes also referred to as hybrid reality) requires an MR headset and typically more processing power than VR or AR applications. Mixed reality does not exclusively take place in either the physical world or virtual world but is a hybrid of AR and VR. To further highlight the difference, AR takes place in the physical world, with information or objects added virtually like an overlay and VR immerses the user in a fully virtual world without the intervention of the physical world. Mixed reality is a blend of physical and digital worlds, unlocking natural and intuitive three-dimensional (3D) human, computer, and environmental interactions. This new reality is based on advancements in computer vision, graphical processing, display technologies, input systems, and cloud computing. As such, AR and VR capabilities are blended, bringing together the physical and digital world to produce an environment where physical and digital objects co-exist and interact in real-time. There are many practical applications of mixed reality, including design, entertainment, military training, and remote working. There are also different display technologies used to facilitate the interaction between users and mixed reality applications.

Extended reality (XR) is a term referring to all real-and-virtual combined environments and human-machine interactions generated by computer technology and wearables and includes representative forms such as AR, VR, and MR, and the areas interpolated among them. The levels of virtuality range from partially sensory inputs to immersive virtuality such that XR is a superset which includes the entire spectrum from the “complete real” to the “complete virtual” in conceptual terms. Still, its connotation lies in the extension of human experiences, especially relating to the senses of existence (represented by VR) and the acquisition of cognition (represented by AR).

As used herein, the term “extended reality (XR)” is an umbrella term for all immersive technologies including, but not limited to, augmented reality (AR), virtual reality (VR), and mixed reality (MR). XR refers to all real-and-virtual combined environments and human-machine interactions generated by computer technology and wearables and includes representative forms such as AR, VR, and MR, and the areas interpolated among them. The levels of virtuality range from partially sensory inputs to immersive virtuality such that XR is a superset which includes the entire spectrum from “the complete real” to “the complete virtual” in conceptual terms. XR's connotation lies in the extension of human experiences especially relating to the senses of existence (represented by VR) and the acquisition of cognition (represented by AR). To that end, as used herein: (i) augmented reality (AR): in an augmented reality, virtual information and objects are overlaid over the real world such that the experience enhances the real world with digital details (e.g., images, text, and animation). An individual may access this user experience through AR glasses or via screens, tablets, or smartphones, for example. In this way, users are not isolated from the real world and may still interact and see what is going on in front of them; (ii) virtual reality (VR): in contrast to AR, a VR experience fully immerses the individual in a simulated digital environment. An individual uses a VR headset or head-mounted display to engage with a 360-degree view of an artificial world that manipulates their brain into believing they are performing or engaging in a particular activity (e.g., walking on the moon, stepping into a castle or whatever environment is created by the VR developers); and (iii) mixed reality (MR): in mixed reality, digital and real world objects co-exist and may interact with one another in real-time. A user employs a MR headset to engage the MR environment that, for example, may place digital objects in a room where the user is standing and give that user the ability to control (e.g., spin) the objects and/or interact with the digital objects in almost any way possible. For example, while the disclosed embodiments herein focus on an AR environment and application it will be understood that the principles described herein are equally applicable to XR, VR, and MR, and the areas interpolated among them. For example, the Apple Vision Pro MR headset employing spatial technology may be employed to create an immersive electronic experience. In an embodiment, a customized visual setting may be created associated with law enforcement encounter and/or the emergency services encounter using one or more keywords identified by the AI algorithms, wherein the customized visual setting created is either a bounded or an unbound immersive environment space. As will be appreciated by those skilled in the art, a bound immersive experience automatically sets a boundary to aid users in awareness of their surroundings when employing an immersive device. Conversely, an unbounded immersive environment can completely transform a user's environment into a virtual space, allowing for a higher level of immersion.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention. A description of an embodiment with several components in communication with each other does not imply that all such components are required. On the contrary, a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. “Software” may refer to prescribed rules to operate a computer. Examples of software may include code segments in one or more computer-readable languages; graphical and/or textual instructions; applets; pre-compiled code; interpreted code; compiled code; and computer programs. A network is a collection of links and nodes (e.g., multiple computers and/or other devices connected together) arranged so that information may be passed from one part of the network to another over multiple links and through various nodes. Examples of networks include the Internet, the public switched telephone network, wireless communications networks, wired communications networks, and computer networks (e.g., an intranet, an extranet, a local-area network, or a wide-area network).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media. When a single device or article is described herein, it will be readily apparent that more than one device/article (whether or not they cooperate) may be used in place of single device/article. Similarly, where more than one device or article is described herein (whether or not they cooperate), it will be readily apparent that a single device/article may be used in place of the more than one device or article. The functionality and/or the features of a device may be alternatively embodied by one or more other devices which are not explicitly described as having such functionality features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-transitory, non-volatile media, volatile media, and transmission media. Non-volatile media include, for example, optical or magnetic disks and other persistent memory. Volatile media include dynamic random access memory (DRAM), which typically constitutes the main memory. Transmission media includes coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, a RAM, a PROM, an EPROM, a FLASH-EEPROM, removable media, flash memory, a “memory stick”, any other memory chip or cartridge, a carrier wave as described hereinafter, or any other medium from which a computer can read. Various forms of computer readable media may be involved in carrying sequences of instructions to a processor. For example, sequences of instruction may be delivered from RAM to a processor, may be carried over a wireless transmission medium, and/or may be formatted according to numerous formats, standards or protocols, such as Bluetooth®, 4G, 5G, etc.

Where databases are described, it will be understood by one of ordinary skill in the art that alternative database structures to those described may be readily employed, and other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a non-transitory computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units. A “network” may refer to a number of computers and associated devices that may be connected by communication facilities. A network may involve permanent connections such as cables or temporary connections such as those made through the telephone or other communication links. A network may further include hard-wired connections (e.g., coaxial cable, twisted pair, optical fiber, waveguides, etc.) and/or wireless connections (e.g., radio frequency waveforms, free space optical waveforms, acoustic waveforms, etc.). Examples of a network may include: an internet, such as the Internet; an intranet; a LAN; a wide area network (WAN); and a combination of networks.

As noted above, in some embodiments the method or methods described above may be executed or carried out by a computing system including a non-transitory computer-readable storage medium, also described herein as a storage machine, that holds machine-readable instructions executable by a logic machine (i.e., a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a GUI, or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that a certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Thus, the steps of the disclosed method(s) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. An AI-based surveillance system for monitoring and protecting an individual's civil rights and assets during a law enforcement encounter using AI-based surveillance, the AI-based surveillance system comprising:
a plurality of surveillance devices aboard a transportation article;
an AI-based surveillance system controller aboard the transportation article and further comprising a processor and a memory storing instructions that when executed cause the processor to perform operations comprising:
recording a real-time surveillance video of the transportation article using at least the AI-based surveillance system controller in combination with the plurality of surveillance devices aboard the transportation article;
monitoring by the AI-based surveillance system using a first plurality of data collected by one or more of the plurality of surveillance devices for an occurrence of a law enforcement encounter involving the transportation article or an emergency services encounter proximate to the transportation article;
responsive to a detection of an occurrence of a law enforcement encounter involving the transportation article:
transmitting a request to receive a recorded video clip for a specified duration prior to the detected law enforcement encounter from the real-time surveillance video recording;
receiving by the AI-based surveillance system the recorded video clip requested;
triggering a start of a real-time law enforcement video recording associated with the detected law enforcement encounter;
responsive to the triggering of the start of the real-time law enforcement video recording, monitoring the law enforcement encounter by the AI-based surveillance system aboard the transportation article using a second plurality of data collected by the plurality of surveillance devices during a time period associated with the law enforcement encounter;
accessing and analyzing by the AI-based surveillance system at least one legal database and retrieving therefrom one or more applicable laws, regulations or ordinances governing the law enforcement encounter;
providing by the AI-based surveillance system, using the one or more applicable laws, regulations or ordinances governing the law enforcement encounter accessed and analyzed, to at least one occupant within the transportation article a legal synopsis of their individual legal rights;
receiving by the AI-based surveillance system one or more occupant questions;
analyzing by the AI-based surveillance system the one or more occupant questions received and transmitting one or more answers thereto to the at least one occupant;
detecting by the AI-based surveillance system an end to the law enforcement encounter;
responsive to the detection of the end of the law enforcement encounter, triggering an end to the real-time law enforcement video recording;
storing a record associated with the law enforcement encounter;
otherwise, responsive to a detection of an occurrence of an emergency services encounter proximate to the transportation article:
sensing by one or more of the plurality of surveillance devices a make-way signal initiated by and associated with the emergency services encounter;
responsive to the make-way signal sensed, confirming by the AI-based surveillance system using a third plurality of data collected by the plurality of surveillance devices at least one emergency vehicle is approaching the transportation article; and
transmitting to a controlling body of the transportation article an emergency yield command to initiate moving the transportation article to a position clear of the approaching at least one emergency vehicle.

2. The AI-based surveillance system of claim 1, wherein the transportation article is either a car or a boat.

3. The AI-based surveillance system of claim 1, wherein the law enforcement encounter is a traffic violation stop.

4. The AI-based surveillance system of claim 1, wherein the plurality of surveillance devices comprise at least one or more cameras, microphones, communications devices, and location-tracking GPS devices.

5. The AI-based surveillance system of claim 1, wherein the operations performed by the processor further comprise:
delivering an immersive environment and experience in the course of the law enforcement encounter or the emergency services encounter using one or more augmented reality (AR) devices, virtual reality (VR) devices, mixed reality (MR) devices and/or extended reality (XR) devices.

6. The AI-based surveillance system of claim 1, wherein the operations performed by the processor further comprise:
collecting by at least one surveillance component of the plurality of surveillance devices a plurality of real-time video streams wherein each real-time video stream represents a different viewing angle of the law enforcement encounter.

7. The AI-based surveillance system of claim 1, wherein the operations performed by the processor further comprise:
initiating, in real-time, a search query of the at least one legal database directed to one or more applicable laws, regulations or ordinances governing the law enforcement encounter.

8. The AI-based surveillance system of claim 1, wherein the operations performed by the processor further comprise:
transmitting the real-time law enforcement video recording associated with the detected law enforcement encounter to a cloud-based database for the storage thereof.

9. The AI-based surveillance system of claim 1, wherein the legal synopsis provided contains at least one civil rights violation with respect to one or more occupants in the transportation article.

10. The AI-based surveillance system of claim 1, wherein the plurality of surveillance devices are located on or within the transportation article.

11. The AI-based surveillance system of claim 1, wherein the operations performed by the processor further comprise:
storing all or a portion of the legal database in a memory device associated with the AI-based surveillance system.

12. The AI-based surveillance system of claim 1, wherein the law enforcement encounter involves at least one law enforcement officer and at least occupant of the transportation article.

13. The system of claim 12, wherein the operations performed by the processor further comprise:
monitoring, using one or more AI agents, one or more interactions between the at least one law enforcement and the at least one occupant of the transportation article.

14. The AI-based surveillance system of claim 1, wherein the controlling body of the transportation article is a driver thereof.

15. An AI-based surveillance system for monitoring and protecting an individual's civil rights and assets during a law enforcement encounter using AI-based surveillance, the AI-based surveillance system comprising:
a plurality of surveillance devices aboard a transportation article;
an AI-based surveillance system controller aboard the transportation article and further comprising a processor and a memory storing instructions that when executed cause the processor to perform operations comprising:
recording a real-time surveillance video of the transportation article using at least the AI-based surveillance system controller in combination with the plurality of surveillance devices aboard the transportation article, wherein the plurality of surveillance devices comprise at least one or more cameras, microphones, communications devices, and location-tracking GPS devices;
monitoring by the AI-based surveillance system using a first plurality of data collected by one or more of the plurality of surveillance devices for an occurrence of a law enforcement encounter involving the transportation article or an emergency services encounter proximate to the transportation article;
responsive to a detection of an occurrence of a law enforcement encounter involving the transportation article:
transmitting a request to receive a recorded video clip for a specified duration prior to the detected law enforcement encounter from the real-time surveillance video recording;
receiving by the AI-based surveillance system the recorded video clip requested;
triggering a start of a real-time law enforcement video recording associated with the detected law enforcement encounter;
responsive to the triggering of the start of the real-time law enforcement video recording, monitoring the law enforcement encounter by the AI-based surveillance system aboard the transportation article using a second plurality of data collected by the plurality of surveillance devices during a time period associated with the law enforcement encounter, and collecting by at least one surveillance component of the plurality of surveillance devices a plurality of real-time video streams, wherein each real-time video stream represents a different viewing angle of the law enforcement encounter;
accessing and analyzing by the AI-based surveillance system at least one legal database and retrieving therefrom one or more applicable laws, regulations or ordinances governing the law enforcement encounter;
providing by the AI-based surveillance system, using the one or more applicable laws, regulations or ordinances governing the law enforcement encounter accessed and analyzed, to at least one occupant within the transportation article a legal synopsis of their individual legal rights;
receiving by the AI-based surveillance system one or more occupant questions;
analyzing by the AI-based surveillance system the one or more occupant questions received and transmitting one or more answers thereto to the at least one occupant;
detecting by the AI-based surveillance system an end to the law enforcement encounter;
responsive to the detection of the end of the law enforcement encounter, triggering an end to the real-time law enforcement video recording;
storing a record associated with the law enforcement encounter;
otherwise, responsive to a detection of an occurrence of an emergency services encounter proximate to the transportation article:
sensing by one or more of the plurality of surveillance devices a make-way signal initiated by and associated with the emergency services encounter;
responsive to the make-way signal sensed, confirming by the AI-based surveillance system using a third plurality of data collected by the plurality of surveillance devices at least one emergency vehicle is approaching the transportation article; and
transmitting to a controlling body of the transportation article an emergency yield command to initiate moving the transportation article to a position clear of the approaching at least one emergency vehicle.

16. The AI-based surveillance system of claim 15, wherein the operations performed by the processor further comprise:
transmitting the record and the real-time law enforcement video recording associated with the detected law enforcement encounter to either a cloud-based database or a local memory device associated with the AI-based surveillance system for the storage thereof.

17. The AI-based surveillance system of claim 15, wherein the operations performed by the processor further comprise:
initiating, in real-time, a search query of the at least one legal database directed to one or more applicable laws, regulations or ordinances governing the law enforcement encounter.

18. The AI-based surveillance system of claim 15, wherein the operations performed by the processor further comprise:
monitoring, by the AI-based surveillance system, one or more interactions between the at least one law enforcement and the at least one occupant of the transportation article.

19. The AI-based surveillance system of claim 15, wherein the plurality of surveillance devices are located on or within the transportation article.

20. An AI-based surveillance system for monitoring and protecting an individual's civil rights and assets during a law enforcement encounter using AI-based surveillance, the AI-based surveillance system comprising:
a plurality of surveillance devices aboard a transportation article;
an AI-based surveillance system controller aboard the transportation article and further comprising a processor and a memory storing instructions that when executed cause the processor to perform operations comprising:
recording a real-time surveillance video of the transportation article using at least the AI-based surveillance system controller in combination with the plurality of surveillance devices aboard the transportation article, wherein the plurality of surveillance devices comprise at least one or more cameras, microphones, communications devices, and location-tracking GPS devices;
monitoring by the AI-based surveillance system using a first plurality of data collected by one or more of the plurality of surveillance devices for an occurrence of a law enforcement encounter involving the transportation article or an emergency services encounter proximate to the transportation article, wherein the law enforcement encounter involves at least one law enforcement officer and at least occupant of the transportation article;
responsive to a detection of an occurrence of a law enforcement encounter involving the transportation article:
transmitting a request to receive a recorded video clip for a specified duration prior to the detected law enforcement encounter from the real-time surveillance video recording, wherein the specified duration prior to the detected law enforcement encounter is at least ten (10) minutes;
receiving by the AI-based surveillance system the recorded video clip requested;
triggering a start of a real-time law enforcement video recording associated with the detected law enforcement encounter;
responsive to the triggering of the start of the real-time law enforcement video recording, monitoring the law enforcement encounter by the AI-based surveillance system aboard the transportation article using a second plurality of data collected by the plurality of surveillance devices during a time period associated with the law enforcement encounter, and collecting by at least one surveillance component of the plurality of surveillance devices a plurality of real-time video streams, wherein each real-time video stream represents a different viewing angle of the law enforcement encounter;
accessing and analyzing by the AI-based surveillance system at least one legal database and retrieving therefrom one or more applicable laws, regulations or ordinances governing the law enforcement encounter;
providing by the AI-based surveillance system, using the one or more applicable laws, regulations or ordinances governing the law enforcement encounter accessed and analyzed, to at least one occupant within the transportation article a legal synopsis of their individual legal rights;
receiving by the AI-based surveillance system one or more occupant questions;
analyzing by the AI-based surveillance system the one or more occupant questions received and transmitting one or more answers thereto to the at least one occupant;
detecting by the AI-based surveillance system an end to the law enforcement encounter;
responsive to the detection of the end of the law enforcement encounter, triggering an end to the real-time law enforcement video recording;
storing a record associated with the law enforcement encounter;
transmitting the record and the real-time law enforcement video recording associated with the detected law enforcement encounter to either a cloud-based database or a local memory device associated with the AI-based surveillance system for the storage thereof;
otherwise, responsive to a detection of an occurrence of an emergency services encounter proximate to the transportation article:
sensing by one or more of the plurality of surveillance devices a make-way signal initiated by and associated with the emergency services encounter;
responsive to the make-way signal sensed, confirming by the AI-based surveillance system using a third plurality of data collected by the plurality of surveillance devices at least one emergency vehicle is approaching the transportation article; and
transmitting to a controlling body of the transportation article an emergency yield command to initiate moving the transportation article to a position clear of the approaching at least one emergency vehicle.
